(19) United States
(12) Patent Application Publication
(10) Pub. No.: US 2004/0048672 A1
(43) Pub. Date: Mar. 11, 2004

(54) Video display unit for video game console

(75) Inventors: Saied Hussaini, Miami, FL (US); Marc Iacovelli, Miami, FL (US)

Correspondence Address: Liniak, Berenato, Longacre & White, Ste. 240, 6550 Rock Spring Drive, Bethesda, MD, 20817, US

(73) Assignee: INTEC INC.

(21) Appl. No.: 10/237,054

(22) Filed: Sep. 9, 2002

(51) Int. Cl. A63F 13/00

(52) U.S. Cl. 463/46

(57) ABSTRACT

A portable video display unit is adapted for use with various electronic video-processing devices, such as video game consoles and video players (DVD players or VCRs). The video display unit comprises a base member adapted for removably attaching the video display unit to the electronic video processing device, the base member including a substantially flat base panel and a video display member including a viewing surface provided with a display screen, the video display member pivotally mounted to the base member for pivoting between a stowed position wherein the video display member is substantially parallel to the base panel and a deployed position wherein the screen member projects outwardly from the base panel with the viewing surface in a disposition which is viewable by a user of the electronic video processing device.

### BACKGROUND OF THE INVENTION

1. Field of the Invention

The present invention relates to consumer electronics, and more particularly to a detachable, compact screen apparatus for an electronic video-processing device, such as a video game console.

2. Description of the Prior Art

Various electronic video-processing devices, such as video game consoles, video players (DVD players or VCRs), etc., are becoming more and more popular. Usually, they include a box-shaped casing provided with as plurality of female plugs for interconnecting to two or more respective control units, a TV monitor and a power adapter. Typically, the electronic video-processing devices are sold separately, without a dedicated display screen, and are adapted to work with conventional TV monitors. Therefore, when children without a TV in their rooms are playing video games or using the video player, they are tying family TV monitors, precluding other household members from watching regular TV shows.

Thus, there is a need for a compact, portable video screen unit adapted to be used with the electronic video-processing devices, in particular with the video game consoles, such as video game systems manufactured by SONY, such as Playstation®2, NINTENDO, such as NINTENDO 64, or SEGA.

### SUMMARY OF THE INVENTION

The present invention provides a novel, portable video display unit for various electronic video-processing devices, especially for video game consoles and video players.

In accordance with the first exemplary embodiment of the present invention, the portable video screen unit is specifically adapted to be used with the Playstation®2 video game console manufactured by SONY Corp. and comprises a base member adapted to be removably attached to the Playstation®2 video game console, and a video display member pivotably mounted on the base member for rotation between a stowed position and a deployed position.

The base member includes a substantially flat base panel, and a screen support member integrally formed with and upwardly extending from a top surface of the base panel adjacent to a rear edge thereof and extending substantially parallel thereto. The screen support member has a front control panel provided with a power switch, a volume control, a screen brightness control, a screen color control, and an earphone plug socket, and a rear panel provided with an S-video input socket, a video input socket, two audio input sockets, a composite audio/video output, and a socket for a DC/AC adapter.

The base panel of the base member further includes an attachment device provided for removably securing the video display unit to the video game console. The screen mounting means device for the Playstation®2 video game console includes a guide flange, a mounting flange, at least one front stop member, and a rear locking tab.

The guide flange extends downwardly from a bottom surface of the base panel substantially perpendicularly thereto and is formed along a side edge thereof. The guide flange frictionally engages the side face of the casing of the PlayStation®2 video game console. Preferably, portion of the guide flange adjacent to the front edge of the base panel is provided with a mounting rib substantially complementary to grooves provided on the front face of the casing of the PlayStation®2.

The mounting flange extends downwardly from the bottom surface of the base panel substantially perpendicularly thereto and is formed along the side edge thereof. The mounting flange in accordance with the first exemplary embodiment of the present invention includes at least one mounting rib formed substantially complementary to grooves provided on a right side face of the casing of the Playstation®2.

Preferably, the screen attachment device is provided with two front stop members adapted to appropriately position the base panel of the video display unit relative to the front face of the casing of the PlayStation®2 video game console. The front stop members are formed at the opposite ends of the front edge of the base panel and extend downwardly therefrom substantially perpendicularly there to the base panel.

Preferably, the base panel is homogeneously formed of strong and durable plastic material as a unitary body integrally with the guide flange, the mounting flange, and the front stop members as a single part plastic molding, thus alleviating the cost of assembling multiple components and simplifying its manufacture.

The rear locking tab is pivotally mounted at the rear edge of the base panel for rotation in a plane substantially perpendicular to the rear edge. The locking tab is of generally L-shaped configuration and has a locking flange provided with a groove adapted to snap one of ribs of a grid provided for covering a ventilating opening on a rear face of the casing of the Playstation®2. The locking tab releasably latches the video display unit onto the PlayStation®2 video game console in a discrete predetermined position with respect thereto.

The video display member includes a hollow display casing pivotally mounted to the screen support member. The display casing houses a display screen. Preferably, the display screen is a substantially flat liquid crystal display (LCD) screen. The display casing further houses a pair of built-in stereo speakers located on both sides of the LCD screen for providing a stereo sound. The video display member can flip up and tilt to the preference of the player to view the screen in the deployed position, or fold down on top of the flat base panel of the base member when not in use for easy storage in the stowed position.

In use, the video display unit is attached to the PlayStation®2 video game console by sliding the base panel over the top surface of the casing from the front face to the rear face thereof so that the guide flange and the mounting flange of the attachment device engage the side faces of the casing while the mounting rib slides into the grooves provided on the right side face of the casing. As the front edge of the base panel aligns to the front face of the casing, the mounting rib of the guide flange slides into the grooves provided on the front face of the casing and the front stop members engage the front face of the casing, thus limiting forward movement of the base panel relative to the casing. Then, the locking tab is rotated downward from its upward stowed position so that it snaps into engagement with one of the horizontal ribs provided on the rear face of the casing of the PlayStation®2. Thus, the video display unit is firmly attached to the casing of the PlayStation®2 video game console.

The second exemplary embodiment of the present invention is substantially identical to the first exemplary embodiment thereof, and only part of the attachment device provided for removably securing the video display unit to the video game console, is different. More specifically, instead of the rear locking tab, the attachment device of the second exemplary embodiment of the present invention employs at least one rear locking tab pivotally mounted at the rear edge of the base member for rotation in a plane substantially parallel to the rear edge thereof. Also, a C-shaped grip member may be provided to retain the video display unit when uplifting force applied.

Therefore, the video screen unit in accordance with the present invention represents a novel arrangement that is compact and portable and adapted to be conveniently used with the electronic video-processing devices, in particular with the video game consoles, such as video game systems manufactured by SONY, such as PlayStation®2, NINTENDO, such as NINTENDO 64, or SEGA, without tying family TV monitor or on the road.

### BRIEF DESCRIPTION OF THE DRAWINGS

Other objects and advantages of the invention will become apparent from a study of the following specification when viewed in light of the accompanying drawings, wherein:

FIG. 1 is a perspective view of a portable video display unit in accordance with the first exemplary embodiment of the present invention in a deployed position;

FIG. 2 is a front view of the video display unit in accordance with the first exemplary embodiment of the present invention in the deployed position;

FIG. 3 is a rear view of the video display unit in accordance with the first exemplary embodiment of the present invention in the deployed position;

FIG. 4 is a left side view of the video display unit in accordance with the first exemplary embodiment of the present invention in the deployed position;

FIG. 5 is a right side view of the video display unit in accordance with the first exemplary embodiment of the present invention in the deployed position;

FIG. 6 is a top view of the video display unit in accordance with the first exemplary embodiment of the present invention in the deployed position;

FIG. 7 is a bottom view of the video display unit in accordance with the first exemplary embodiment of the present invention in the deployed position;

FIG. 8 is a perspective view of a portable video display unit in accordance with the first exemplary embodiment of the present invention in a stowed position;

FIG. 9 is a perspective view of a PlayStation®2 video game console manufactured by SONY Corp.;

FIG. 10 is a perspective view of the video display unit of the first exemplary embodiment of the present invention partially assembled to the PlayStation®2 video game console;

FIG. 11 is a perspective view of the video display unit of the first exemplary embodiment of the present invention fully assembled to the PlayStation®2 video game console;

FIG. 12 is a partial rear view of the video display unit of the first exemplary embodiment of the present invention attached to the PlayStation®2 video game console;

FIG. 13 is a cross sectional view along the line 12-12 in FIG. 12;

FIG. 14 is a perspective view of a portable video display unit in accordance with the second exemplary embodiment of the present invention in a deployed position;

FIG. 15 is a front view of the video display unit in accordance with the second exemplary embodiment of the present invention in the deployed position;

FIG. 16 is a rear view of the video display unit in accordance with the second exemplary embodiment of the present invention in the deployed position;

FIG. 17 is a left side view of the video display unit in accordance with the second exemplary embodiment of the present invention in the deployed position;

FIG. 18 is a right side view of the video display unit in accordance with the second exemplary embodiment of the present invention in the deployed position;

FIG. 19 is a bottom view of the video display unit in accordance with the second exemplary embodiment of the present invention in the deployed position;

FIG. 20 is a partial rear view of the video display unit of the second exemplary embodiment of the present invention attached to the PlayStation®2 video game console;

FIG. 21 is a cross sectional view along the line 21-21 in FIG. 20.

### DETAILED DESCRIPTION OF PREFERRED EMBODIMENTS

The preferred embodiments of the present invention will now be described with the reference to accompanying drawings.

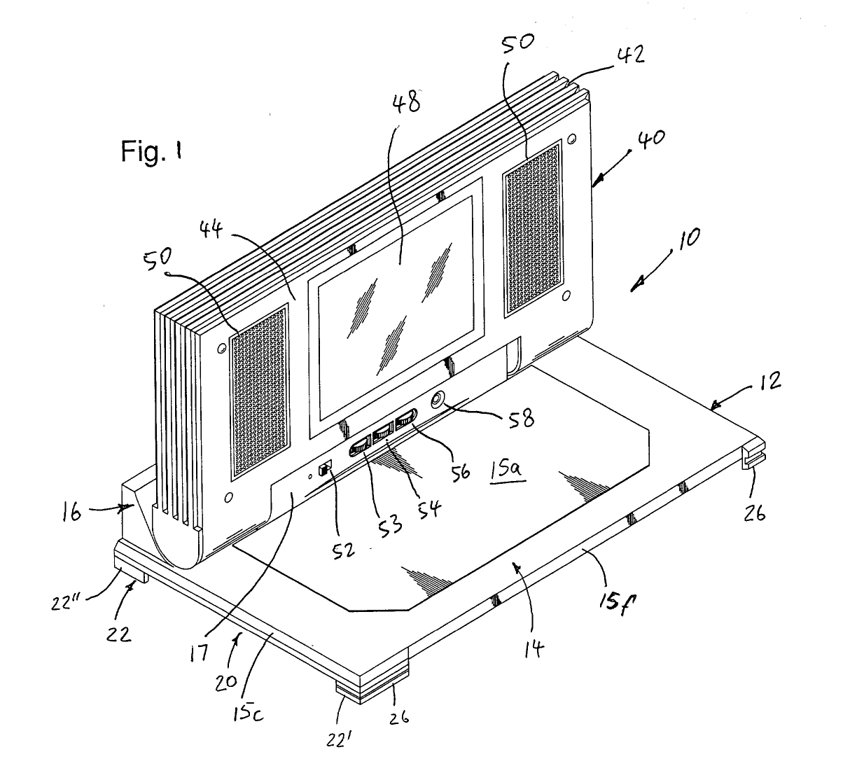

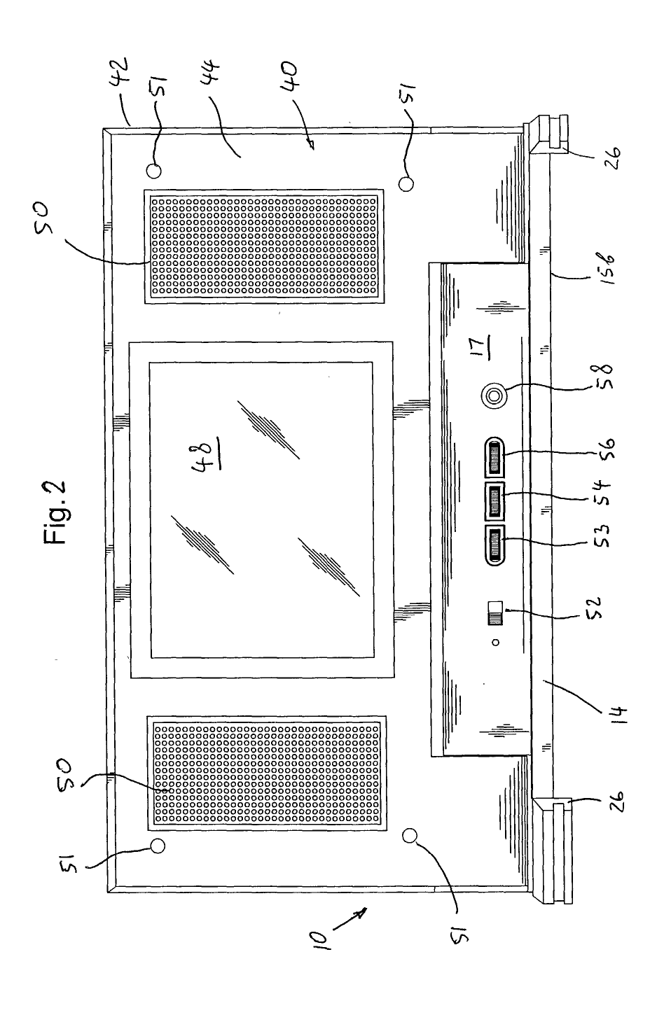

FIGS. 1-8 of the drawings illustrates the first exemplary embodiment of a video display unit in accordance with the present invention, generally indicated at 10. The video display unit 10 comprises a base member 12 adapted to be removably attached to an electronic video processing device, such as a conventional video game console, and a video display member 40 pivotably mounted on the base member 12. The examples of the video game consoles include video game systems manufactured by SONY, such as PlayStation®2, NINTENDO, such as NINTENDO 64, or SEGA. However, it is to be understood that while the present invention is described in relation to the video game consoles, the present invention is equally suitable for use in other electronic video processing devices, such as DVD or VHS video players.

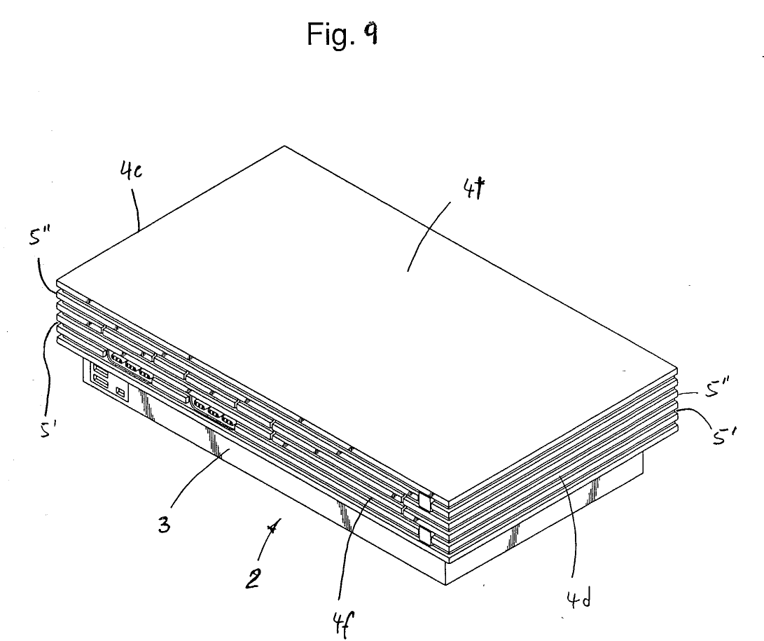

The particular first exemplary embodiment of the present invention illustrated in FIGS. 1-8, is specifically applicable to the video game console PlayStation®2 manufactured by SONY Corp. The typical PlayStation®2 video game console, generally indicated at 2 and illustrated in FIGS. 9-11, includes a substantially box-like casing 3 having a top surface 4t and a bottom surface, a front face 4f, a rear face 4r, and opposite side faces 4c and 4d. The front face 4f and the side faces 4d of the casing 3 of the PlayStation®2 is provided with a plurality of alternating, substantially horizontally extending grooves and ribs 5′ and 5″ respectively. The rear face 4r of the casing 3 includes a ventilating opening covered with a grid 6 of mutually orthogonal vertical and horizontal ribs 6v and 6h, as illustrated in FIG. 11.

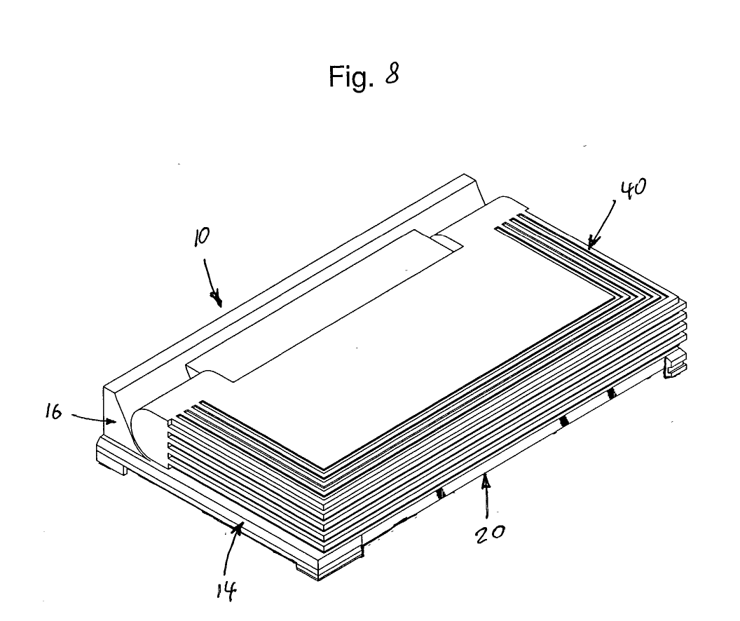

The base member 12 includes a substantially flat base panel 14 having a top surface 15a and a bottom surface 15b, a front edge 15f, a rear edge 15r, and opposite side edges 15c and 15d. The base member 12 further includes a screen support member 16 integrally formed with and upwardly extending from the top surface 15a of the base panel 14 adjacent to the rear edge 15r and extending substantially parallel thereto, as illustrated in FIGS. 1, 4 and 5. The screen support member 16 is adapted for pivotally supporting the video display member 40 between a stowed position (shown in FIG. 8) and a deployed position (shown in FIG. 1).

The screen support member 16 has a front control panel 17 and a rear panel 18. The control panel 17 is provided with a power switch 52, a volume control 53, a screen brightness control 54, a screen color control 56, and an earphone plug socket 58. The rear panel 18 is provided with an S-video input socket 60, a video input socket 62, two audio input sockets 64, a composite audio/video output 66, and a socket 68 for a DC/AC adapter (not shown). The sockets 60, 62, 64 and 66 define a screen electrical interface adapted to be operably connected to an electrical interface of the PlayStation®2 video game console 2 and communicate electrical signals therebetween.

The base panel 14 of the base member 12 further includes an attachment device 20 provided for removably securing the video display unit 10 to the video game console 2. The attachment device 20 for the PlayStation®2 video game console 2 includes a guide flange 22, a mounting flange 24, at least one front stop member 26, and a rear locking tab 28.

The guide flange 22 extends downwardly from the bottom surface 15b of the base panel 14 substantially perpendicularly thereto and is formed along the side edge 15c thereof. Preferably, the guide flange 22 of the attachment device 20 of the first exemplary embodiment of the present invention includes two guide plates 22′ and 22″ each adjacent to the opposite front and rear edges 15f and 15r of the base panel 14. The guide plates 22′ and 22″ frictionally engage the side face 4c of the casing 3 of the PlayStation®2 video game console 2. Preferably, the guide plates 22″ adjacent to the front edge 15f of the base panel 14 is provided with a mounting rib 23 substantially complementary to the grooves 5′ provided on the front face 4f of the casing 3 of the PlayStation®2.

The mounting flange 24 extends downwardly from the bottom surface 15b of the base panel 14 substantially perpendicularly thereto and is formed along the side edge 15d thereof. The mounting flange 24 in accordance with the first exemplary embodiment of the present invention includes at least one mounting rib 25 formed substantially complementary to the grooves 5′ provided on the side face 4d of the casing 3 of the PlayStation®2. Preferably, the mounting flange 24 is integrally formed with the mounting rib 25. Alternatively, the mounting flange 24 may be provided with two or more of the mounting ribs 25.

Preferably, as illustrated in FIGS. 1-7, the screen attachment device 20 is provided with two front stop members 26 adapted to appropriately position the base panel 14 of the video display unit 10 relative to the front face 4f of the casing 3 of the PlayStation®2 video game console 2. The front stop members 26 are formed at the opposite ends of the front edge 15f of the base panel 14 and extend downwardly therefrom substantially perpendicularly there to the base panel 14.

Preferably, the base panel 14 is homogeneously formed of strong and durable plastic material as a unitary body integrally with the guide plates 22′ and 22″, the mounting flange 24, and the front stop members 26 as a single part plastic molding, thus alleviating the cost of assembling multiple components and simplifying its manufacture.

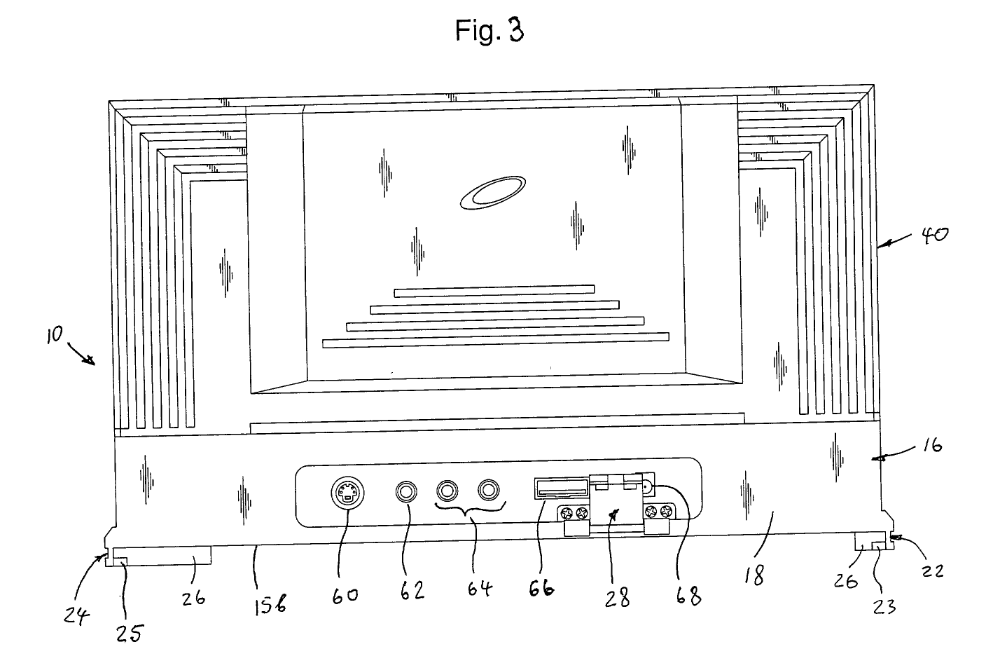

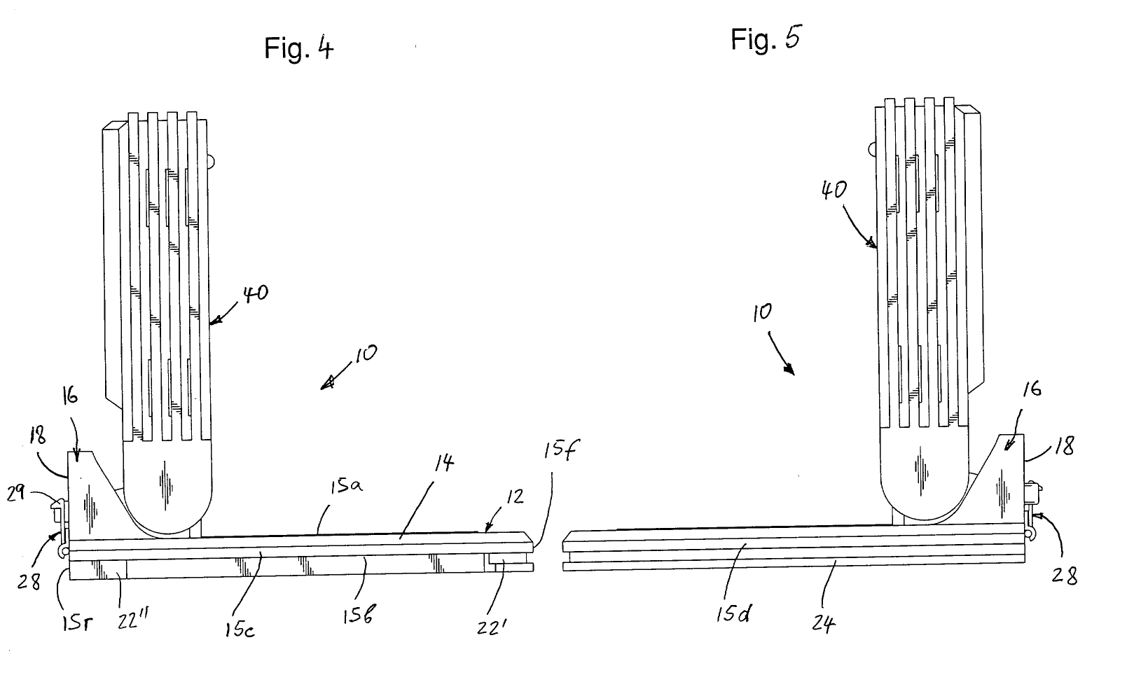

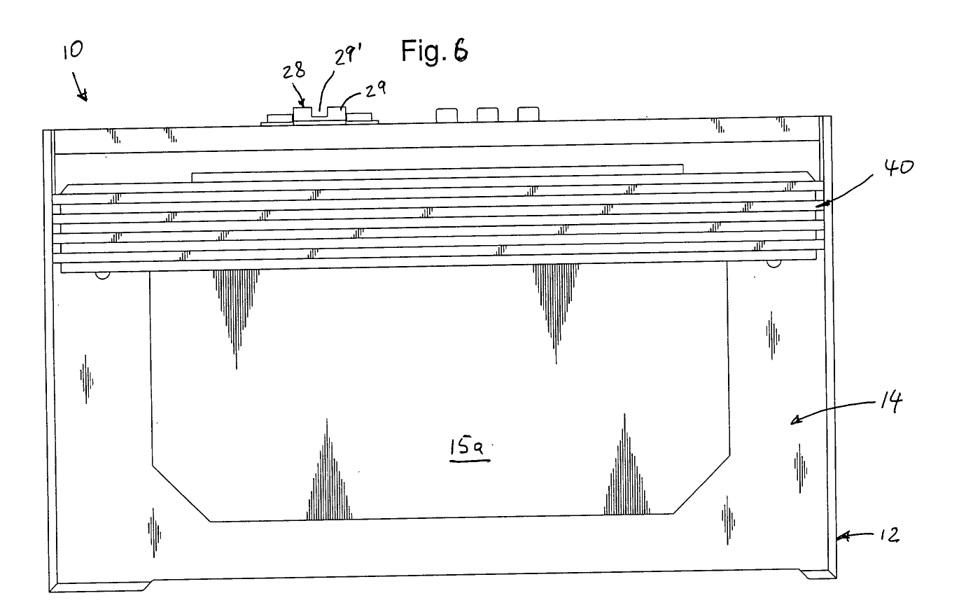

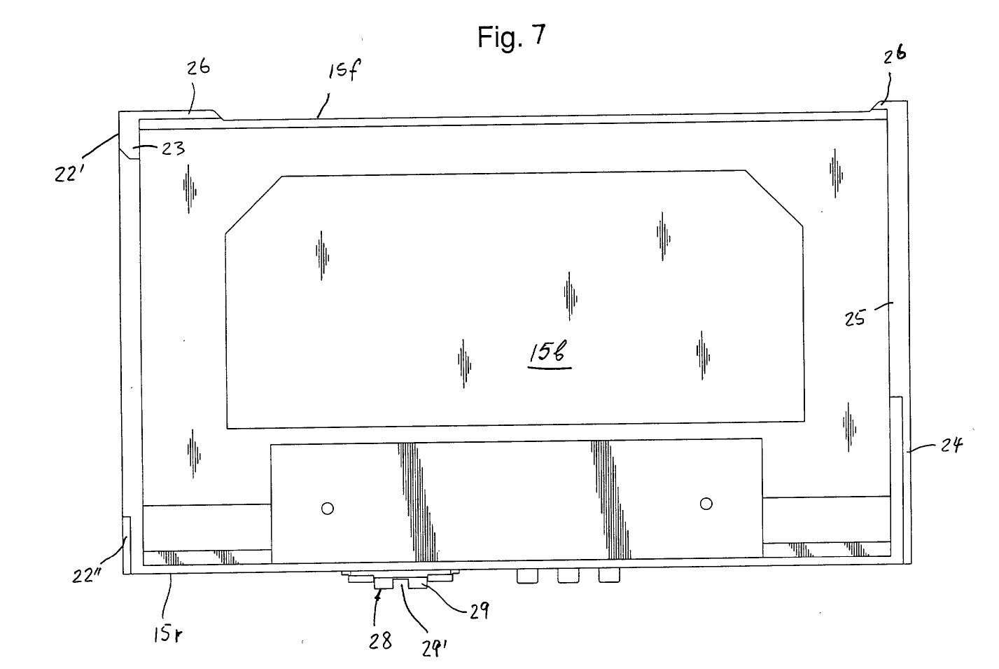

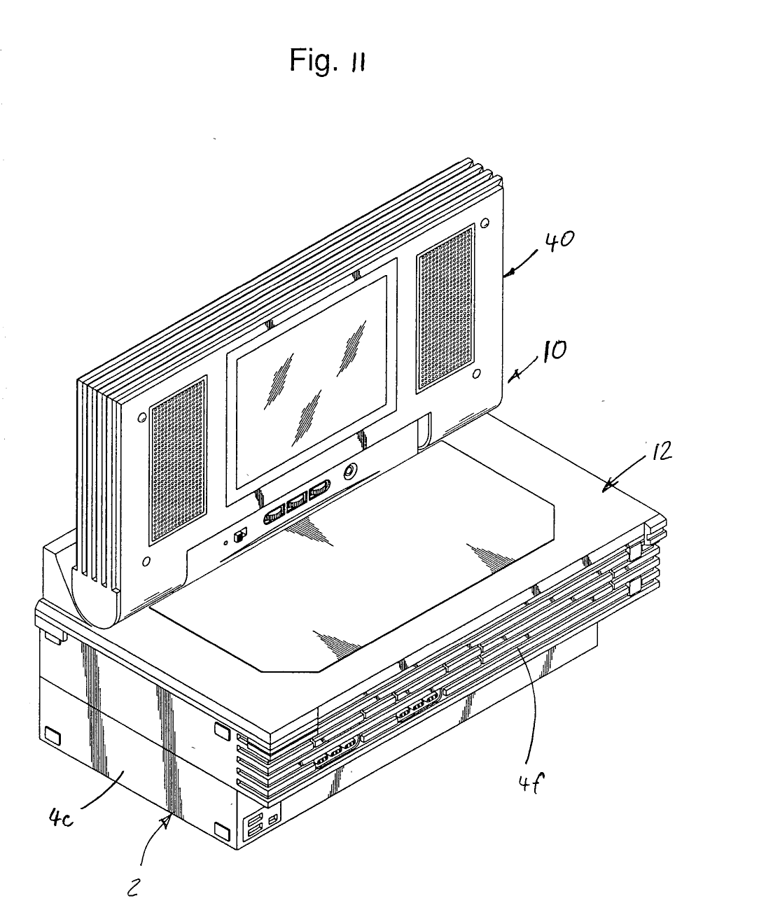

As illustrated in FIGS. 3-5, 11 and 12, the rear locking tab 28 is pivotally mounted at the rear edge 15r of the base panel 14 for rotation in a plane substantially perpendicular to the rear edge 15r. As illustrated in FIGS. 4 and 12, the locking tab 28 is of generally L-shaped configuration and has a locking flange 29 provided with a groove 29′ (shown in FIGS. 6 and 7) adapted to receive one of the vertical ribs 5v provided on the rear face 4r of the casing 3 of the PlayStation®2. The locking tab 28 releasably locks the video display unit 10 onto the PlayStation®2 video game console 2 in a discrete predetermined position with respect thereto by engaging one of the vertical ribs 5v of the casing 3 (as shown in FIGS. 11 and 12).

The video display member 40 includes a hollow display casing 42 made of, preferably, appropriate plastic material. The display casing 42 is pivotally mounted to the screen support member 16 and has a front, viewing surface 44 and a back surface 46. The display casing 42 houses a display screen 48 viewable on the viewing surface 44. Preferably, the display screen 48 is a substantially flat liquid crystal display (LCD) screen. The display casing 42 further houses a pair of built-in stereo speakers 50 located on both sides of the LCD screen 48 for providing a stereo sound. Also, a plurality (preferably four) of elastic pad members 51 are provided on the viewing surface 44 of the display casing 42 adapted to provide a small clearance between the video display member 40 and the base panel 14 when the video display unit 10 is in the stowed position.

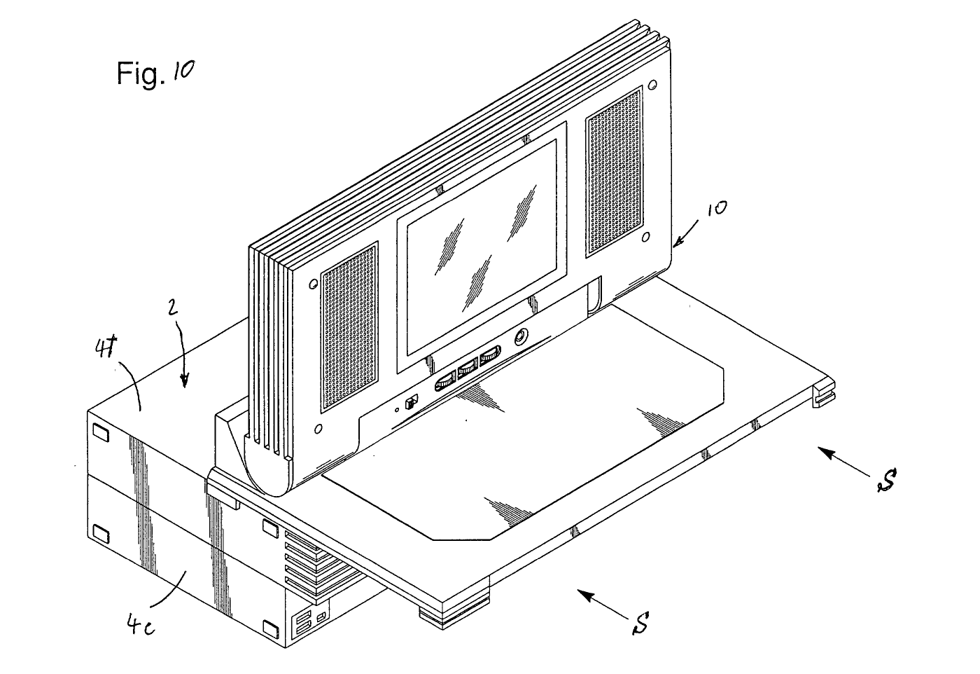

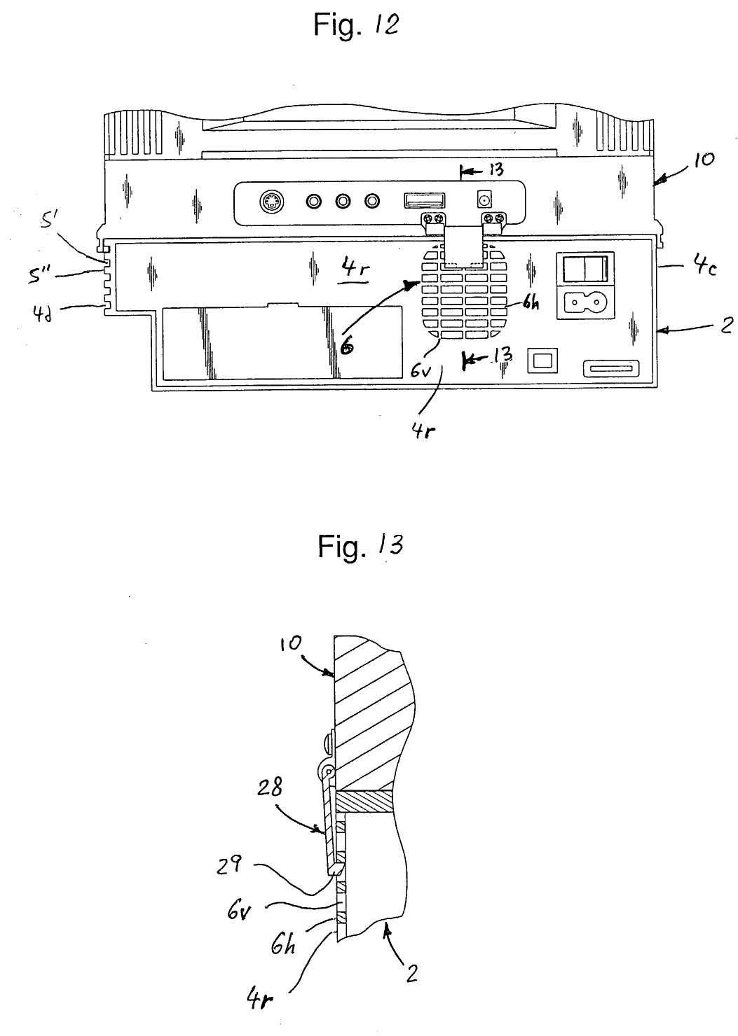

In use, the video display unit 10 is attached to the casing 3 of the PlayStation®2 video game console 2 by sliding the base panel 14 over the top surface 4t of the casing 3 in the direction of arrows S, as shown in FIG. 10, from the front face 4f to the rear face 4r thereof so that the guide flange 22 and the mounting flange 24 of the attachment device 20 engage the side faces 4c and 4d of the casing 3 while the mounting rib 25 slides into the grooves 5′ provided on the side face 4d of the casing 3. As the front edge 15f of the base panel 14 aligns to the front face 4f of the casing 3, the mounting rib 23 of the guide plate 22″ slides into the grooves 5′ provided on the front face 4f of the casing 3 and the front stop members 26 engage the front face 4f of the casing 3, thus limiting forward movement of the base panel 14 relative to the casing 3, as shown in FIG. 11. Then, the locking tab 28 is rotated downward from its upward stowed position so that the groove 29′ in the locking flange 29 thereof snaps into engagement with one of the vertical ribs 6v of the grid 6 provided on the rear face 4r of the casing 3 of the PlayStation®2, as illustrated in FIGS. 12 and 13. Thus, the video display unit 10 is firmly attached to the casing 3 of the PlayStation®2 video game console 2.

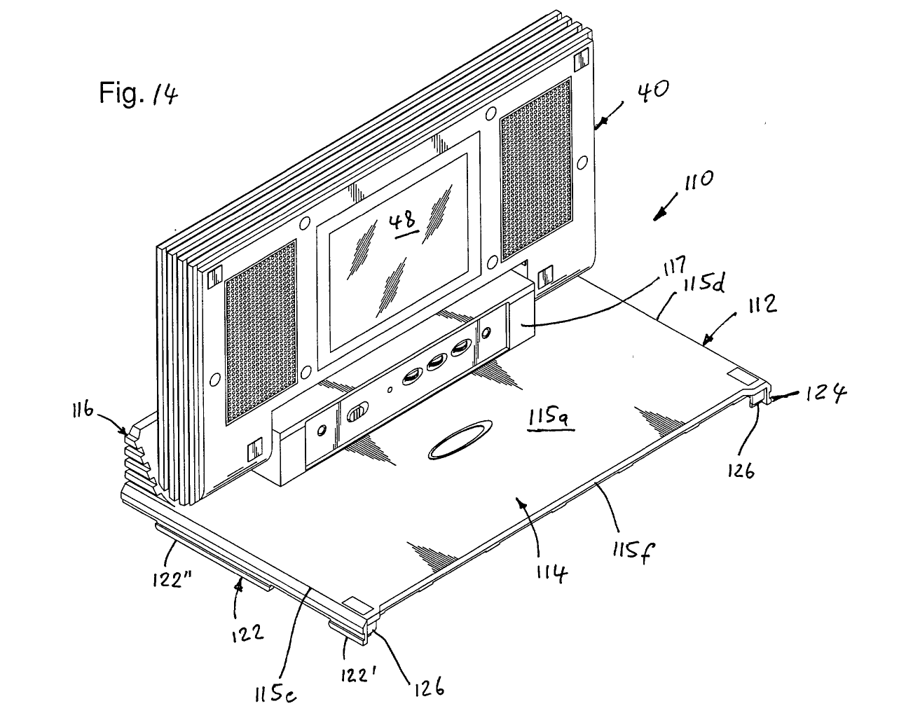

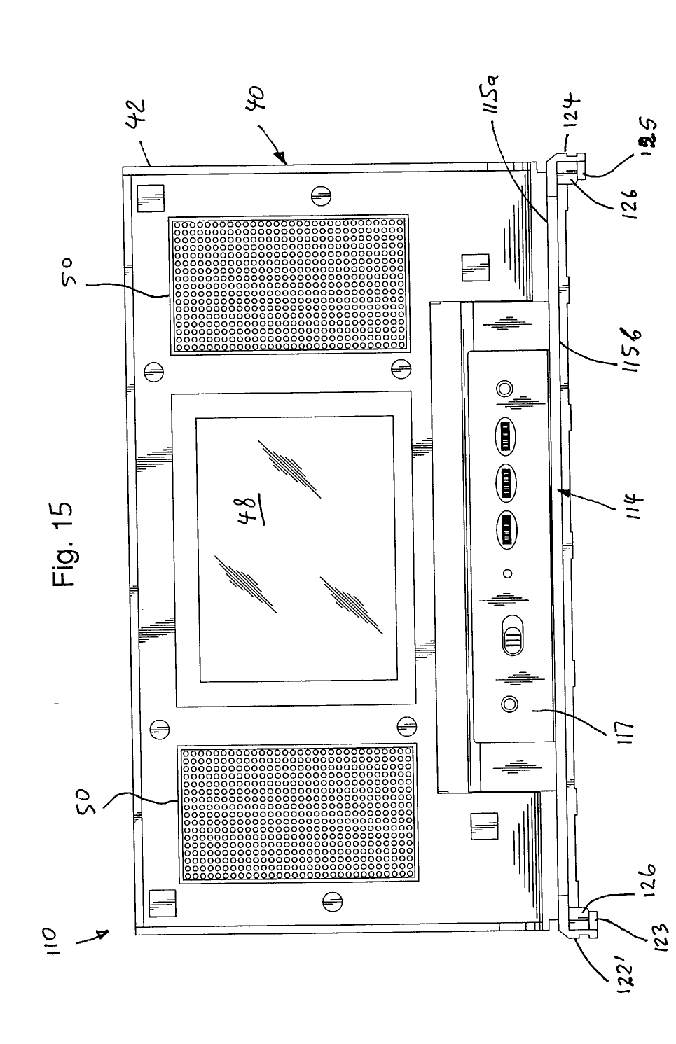

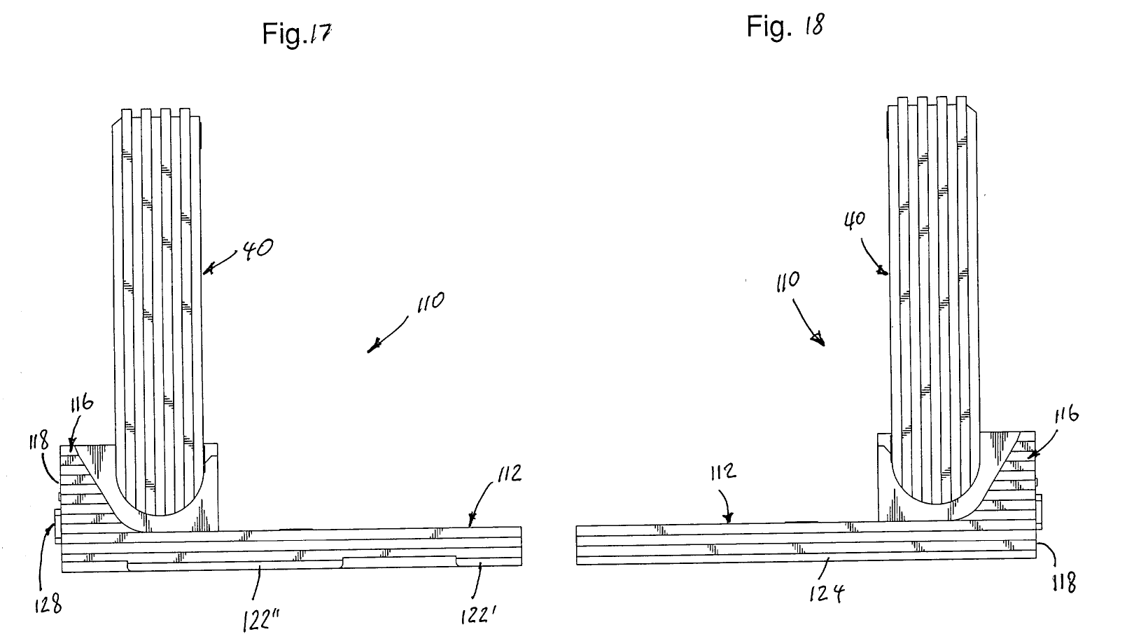

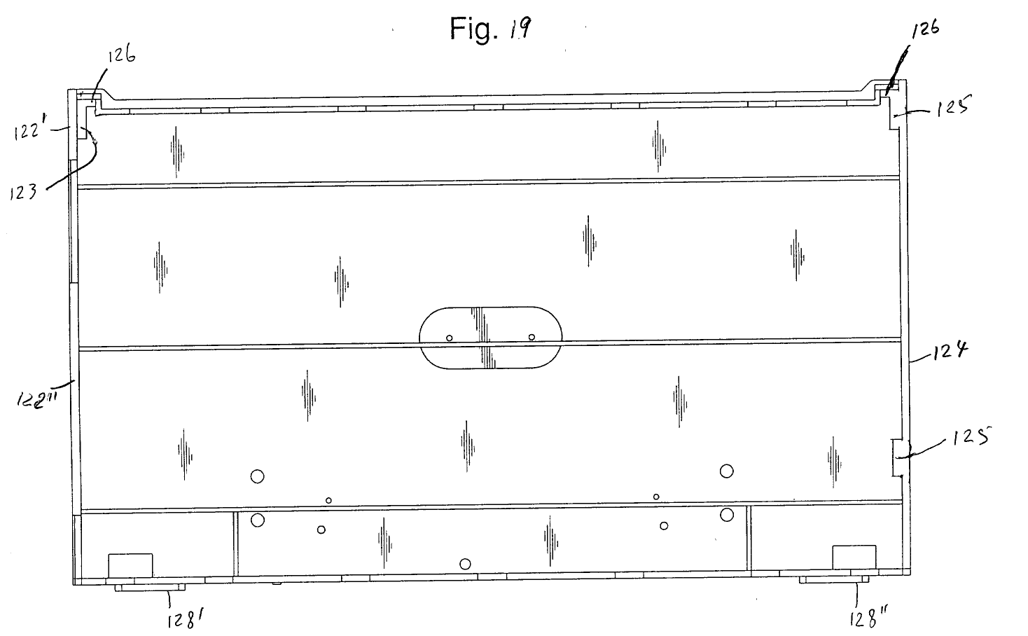

FIGS. 14-21 of the drawings illustrate the second exemplary embodiment of a video display unit, generally indicated at 110. Components, which are unchanged from, or function in the same way as in the first exemplary embodiment depicted in FIGS. 1-8 are labeled with the same reference numerals, sometimes without describing detail since similarities between the corresponding parts in the two embodiments will be readily perceived by the reader.

The video display unit 110 of the second exemplary embodiment, as illustrated in FIGS. 14-19, comprises a base member 112 adapted to be removably attached to an electronic video processing device, such as a conventional video game console 2, and a video display member 40 pivotably mounted on the base member 112.

The second exemplary embodiment of the present invention is also specifically applicable to the video game console PlayStation®2 manufactured by SONY Corp.

The base member 112 is substantially similar to the base member 12 in accordance with first examplery embodiment of the present invention and includes a substantially flat base panel 114 having a top surface 115a and a bottom surface 115b, a front edge 115f, a rear edge 115r, and opposite side edges 115c and 115d. The base member 112 further includes a screen support member 116 integrally formed with and upwardly extending from the top surface 115a of the base panel 114 adjacent to the rear edge 115r and extending substantially parallel thereto, as illustrated in FIGS. 14-19. The screen support member 116 has a front control panel 117 and a rear panel 118. The screen support member 116 is adapted for pivotally supporting the video display member 40 between a stowed position and a deployed position.

The base panel 114 of the base member 112 further includes an attachment device 120 provided for removably securing the video display unit 110 to the video game console 2. The screen mounting means device 120 for the PlayStation®2 video game console 2 includes a guide flange 122, a mounting flange 124, a pair of front stop members 126, and two rear locking tabs 128 and 128.

The guide flange 122, the front stop members 126 and the mounting flange 124 are substantially identical to the guide flange 22, the front stop members 26 and the mounting flange 24 of the attachment device 20 in accordance with the second exemplary embodiment of the present invention.

The guide flange 122 extends downwardly from the bottom surface 115b of the base panel 114 substantially perpendicularly thereto and is formed along the side edge 115c thereof. Preferably, the guide flange 122 of the attachment device 120 includes two guide plates 122′ and 122″ each adjacent to the opposite front and rear edges 115f and 115r of the base panel 114, respectively. The guide plates 122′ and 122″ frictionally engage the side face 4c of the casing 3 of the PlayStation®2 video game console 2. Preferably, the guide plates 122′ adjacent to the front edge 15f of the base panel 114 is provided with a mounting rib 123 substantially complementary to the grooves 5′ provided on the front face 4f of the casing 3 of the PlayStation®2.

The mounting flange 124 extends downwardly from the bottom surface 115b of the base panel 114 substantially perpendicularly thereto and is formed along the side edge 115d thereof. The mounting flange 124 in accordance with the second exemplary embodiment of the present invention includes two mounting rib 125 formed substantially complementary to the grooves 5′ provided on the side face 4d of the casing 3 of the PlayStation®2. Preferably, the mounting flange 124 is integrally formed with the mounting ribs 125.

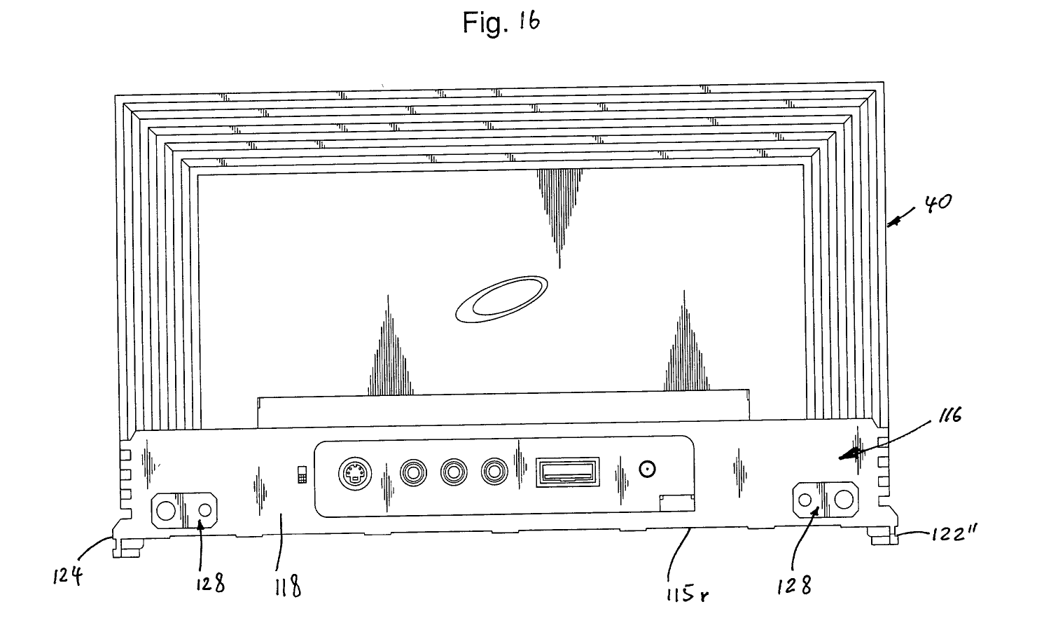

As illustrated in FIGS. 16-20, the rear locking tabs 128 are pivotally mounted to the rear panel 118 of the screen support member 116 at the rear edge 115r of the base panel 114 for rotation in a plane substantially parallel to the rear edge 115r. The locking tabs 128 are in the form of generally rectangular, flat plates adapted to rotate relative to the base member 112 to a position to engage the rear face of the casing 3 so as to releasably lock the video display unit 110 onto the PlayStation®2 video game console 2 in a discrete predetermined position with respect thereto by engaging the rear face 4r of the casing 3.

The manner the video display unit 110 of the second exemplary embodiment of the present invention is attached to the casing 3 of the PlayStation®2 video game console 2 is substantially similar to that of the first exemplary embodiment of the present invention.

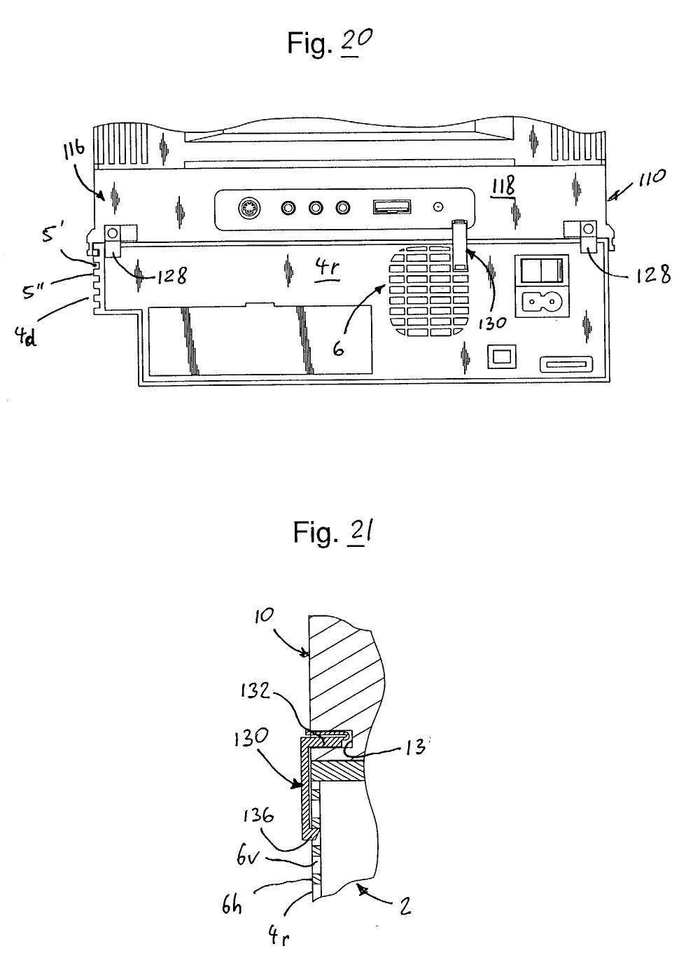

The base panel 114 of the video display unit 110 slides over the top surface 4t of the casing 3 from the front face 4f to the rear face 4r thereof so that the guide flange 122 and the mounting flange 124 of the attachment device 120 engage the side faces 4c and 4d of the casing 3 while the mounting rib 125 slides into the grooves 5′ provided on the side face 4d of the casing 3. As the front edge 115f of the base panel 114 aligns to the front face 4f of the casing 3, the mounting rib 123 of the guide plate 122′ slides into the grooves 5′ provided on the front face 4f of the casing 3 and the front stop members 126 engage the front face 4f of the casing 3, thus limiting forward movement of the base panel 114 relative to the casing 3. Then, the locking tabs 128 are rotated downward so that they engage the rear face 4r of the casing 3 of the PlayStation®2, as illustrated in FIG. 20. Thus, the video display unit 110 is firmly secured to the casing 3 of the PlayStation®2 video game console 2.

Optionally, the video display unit 110 may include a C-shaped grip member 130 adapted for interlocking the video display unit 110 and the casing 3 of the PlayStation®2. The C-shaped grip member 130 has a first locking flange 132 releasably engaging an opening 134 in the rear face 4r of the casing 3 of the PlayStation®2, and a second locking flange 136 releasably engaging the grid 6 provided on the rear face 4r of the casing 3 of the PlayStation®2, as illustrated in FIGS. 20 and 21.

Therefore, the video screen unit in accordance with the present invention represents a novel arrangement that is compact and portable and adapted to be conveniently used with the electronic video-processing devices, in particular with the video game consoles, such as video game systems manufactured by SONY, such as PlayStation®2, NINTENDO, such as NINTENDO 64, or SEGA.

The foregoing description of the preferred embodiments of the present invention has been presented for the purpose of illustration in accordance with the provisions of the Patent Statutes. It is not intended to be exhaustive or to limit the invention to the precise forms disclosed. The embodiments disclosed hereinabove were chosen in order to best illustrate the principles of the present invention and its practical application to thereby enable those of ordinary skill in the art to best utilize the invention in various embodiments and with various modifications as are suited to the particular use contemplated, as long as the principles described herein are followed. This application is therefore intended to cover any variations, uses, or adaptations of the invention using its general principles. Further, this application is intended to cover such departures from the present disclosure as come within known or customary practice in the art to which this invention pertains. Thus, changes can be made in the above-described invention without departing from the intent and scope thereof. It is also intended that the scope of the present invention be defined by the claims appended thereto.

What is claimed is:

1. A portable video display unit comprising:
a base member adapted for removably attaching said video display unit to an electronic video processing device, said base member including a substantially flat base panel; and
a video display member including a viewing surface provided with a display screen, said video display member pivotally mounted to said base member for pivoting between a stowed position wherein said video display member is substantially parallel to said base panel and a deployed position wherein said video display member projects outwardly from said base panel with said display screen in a disposition which is viewable by a user of said electronic video processing device.

2. The portable video display unit as defined in claim 1, wherein said base member includes an attachment device provided for removably securing said video display unit to said electronic video processing device.

3. The portable video display unit as defined in claim 2, wherein said attachment device includes a guide flange extending downwardly from one side edge of said base member, a mounting flange extending downwardly from the other side edge of said base member, at least one front stop member extending downwardly from a front edge of the said base member and at least one locking tab pivotally mounted to a rear panel of said base member for releasably locking said video display unit onto said electronic video processing device in a discrete predetermined position with respect thereto.

4. The portable video display unit as defined in claim 3, wherein said electronic video processing device is a video game console.

5. The portable video display unit as defined in claim 4, wherein said video game console includes a casing having opposite side faces, a front face and a rear face, said front face and one of said side faces of the casing provided with a plurality of substantially horizontally extending grooves.

6. The portable video display unit as defined in claim 5, wherein said mounting flange has at least one mounting rib adapted to engage one of said grooves of one of said side faces of said casing of said video game console, wherein said guide flange has mounting rib adjacent to said front edge of the said base member adapted to engage one of said grooves of said front faces of said casing of said video game console, and wherein said at least one locking tab is adapted to engage said rear face of said casing of said video game console.

7. The portable video display unit as defined in claim 6, said at least one locking tab is rotatable in a plane substantially perpendicular to said rear panel of said base member.

8. The portable video display unit as defined in claim 7, wherein said rear face of said casing of said video game console includes a cooling opening covered with a grid of mutually orthogonal vertical and horizontal ribs and said at least one locking tab is provided with a groove at a distal end thereof adapted to engage one of said horizontal ribs.

9. The portable video display unit as defined in claim 6, including two locking tabs each rotatable in a plane substantially parallel to said rear panel of said base member.

10. The portable video display unit as defined in claim 1, wherein said base member includes a substantially flat base panel and a screen support member extending upward from said base panel adjacent to a rear edge thereof, said video display member being pivotally mounted to said screen support member.

11. The portable video display unit as defined in claim 10, wherein said screen support member has a front panel provided with a power switch and a plurality of controls for regulating said display screen.

12. The portable video display unit as defined in claim 11, wherein said front panel is further provided with an earphone plug socket.

13. The portable video display unit as defined in claim 10, wherein said screen support member has a rear panel provided with at least one electrical connector adapted to be detachably electrically connected to a corresponding electrical connector on said electronic video processing device through an extension cable.

14. The portable video display unit as defined in claim 1, wherein said video display member is further provided with a pair of stereophonic loudspeakers.

15. The portable video display unit as defined in claim 1, further comprising a display controller for electrically connecting said video display unit to said electronic video processing device.

16. The portable video display unit as defined in claim 15, wherein said display controller has at least one electrical connector adapted to be detachably electrically connected to a corresponding electrical connector on said electronic video processing device through an extension cable.

17. The portable video display unit as defined in claim 4, wherein said attachment device includes a C-shaped grip member for interlocking said video display unit and a casing 3 of said video game console.
